(19) United States
(12) Patent Application Publication
(10) Pub. No.: US 2007/0075911 A1
(43) Pub. Date: Apr. 5, 2007

(54) ANTENNA DEVICE USED IN RADIO-COMMUNICATIONS WITHIN SHORT COMMUNICATION RANGE AND ARTICLE CONTAINER

(75) Inventors: Jun Yaginuma, Shizuoka (JP); Naohiro Matsushita, Shizuoka (JP); Sadatoshi Oishi, Shizuoka (JP)

Correspondence Address: DLA PIPER US LLP, P. O. BOX 9271, RESTON, VA, 20195, US

(73) Assignee: Toshiba TEC Kabushiki Kaisha, Tokyo (JP)

(21) Appl. No.: 11/538,676

(22) Filed: Oct. 4, 2006

(30) Foreign Application Priority Data
Oct. 5, 2005 (JP) P2005-292572

(51) Int. Cl. H01Q 21/00

(52) U.S. Cl. 343/853; 340/10.1; 340/572.1; 455/41.2; 235/385; 343/876

(57) ABSTRACT

There is provided an antenna device used in a radio-communication between a radio communication apparatus and a data carrier within a short communication range. The antenna device comprises first and second leakage transmission lines, and a switch for selectively connecting the first and second transmission lines to the radio communication apparatus when carrying out the radio communication. The first transmission line has an opened end terminal. The second transmission line has a short-circuited end terminal. The first and second transmission lines are arranged in parallel and end terminals thereof are aligned.

### BACKGROUND OF THE INVENTION

(1) Field of the Invention

The present invention relates, in general, to an antenna and an article container and, in particular, to an antenna device for radio-communications between a radio communication apparatus and a data carrier, e.g., an RFID tag attached to an article within a short communication range and an article container equipped with the antenna device.

(2) Description of the Related Art

Conventionally, a management system disclosed in Japanese Patent Publication (Kokai) No. 2004-102947 is known to manage articles, e.g., books, compact discs (CD) and so on, aligned on shelves. In such a system, an RFID (Radio Frequency Identification) tag and a handy scanner are employed. The RFID tag is attached to a back surface of each book on the shelves and the RFID tags are scanned by the scanner one by one. Data stored in the RFID tag is thus read by the scanner and is transmitted to a personal computer to carry out an inventory management or a tracking management, for example.

The above-described system, however, poses a low operation efficiency, because an operator must scan each of the RFID tags attached to the books on the shelves one by one and the communication between each of the RFID tags and the handy scanner is made through an antenna provided in the handy scanner.

Japanese Patent Publication (Kokai) No. 2005-182352 discloses another book management system used in libraries or bookstores to manage location and/or inventory of books therein. The system includes RFID tags and an RFID tag reader mounted on the bookshelf. When a book on which RFID tag is attached is put onto the bookshelf, such an operation brings the RFID tag of the book into a readable area of the reader and thus data stored in the RFID tag can be obtained through the reader to identify the book on the bookshelf.

The above-described another system may raise a low data readability that failure to read data from the RFID tag may occur because radio wave transmitted from the RFID tag reader has a partially low intensity of electric field.

### SUMMERY OF THE INVENTION

An object of the present invention is to provide an improved antenna device used in a radio communication between a radio communication apparatus and a plurality of data carriers, such as RFID tags, within a short communication range, thereby improving a machine-readability between data carriers and a radio communication apparatus.

To accomplish the above-mentioned object, an antenna device used in a radio-communication between a radio communication apparatus and a data carrier within a short communication range, comprising:
a first leakage transmission line, functioning as an antenna element, which generates leakage radio waves having a first distribution pattern in an electric field intensity;
a second leakage transmission line, functioning as an antenna element, which generates leakage radio waves having a second distribution pattern in an electric field intensity, the second distribution pattern being shifted by λg/4 with respect to the first distribution pattern where λg is a wavelength propagating in the first and second transmission lines; and
a switch configured to selectively connect the first and second transmission lines to the radio communication apparatus when carrying out the radio communication.

### BRIEF DESCRIPTION OF THE DRAWINGS

These and other objects and advantages of this invention will become apparent and more readily appreciated from the following detailed description of the presently preferred exemplary embodiments of the invention taken in conjunction with the accompanying drawings wherein:

FIG. 1 is a perspective view showing an entire structure in a first embodiment of the present invention;

FIG. 2 is a plan view showing the entire structure in the first embodiment;

FIG. 3 is a block diagram indicating a structure of an antenna device within a short communication range in the first embodiment;

FIG. 4 is a block diagram indicating a structure of an antenna device within a short communication range in a second embodiment of the present invention;

FIG. 5 is a plan view showing the entire structure in a third embodiment;

FIG. 6 is a block diagram indicating a structure of an antenna device within a short communication range in the third embodiment;

FIG. 7 is a block diagram indicating a structure of an antenna device in a short communication range in a fourth embodiment of the present invention;

FIG. 8 is a block diagram indicating a structure of an antenna device within a short communication range in a fifth embodiment of the present invention: and

FIG. 9 is a block diagram indicating a structure of an antenna device within a short communication range in a sixth embodiment of the present invention.

### DEATAILED DESCRIPTION OF THE INVENTION

The present invention will now be described in more detail with reference to the accompanying drawings. However, the same numerals are applied to the similar elements in the drawings, and therefore, the detailed descriptions thereof are not repeated.

### First Embodiment

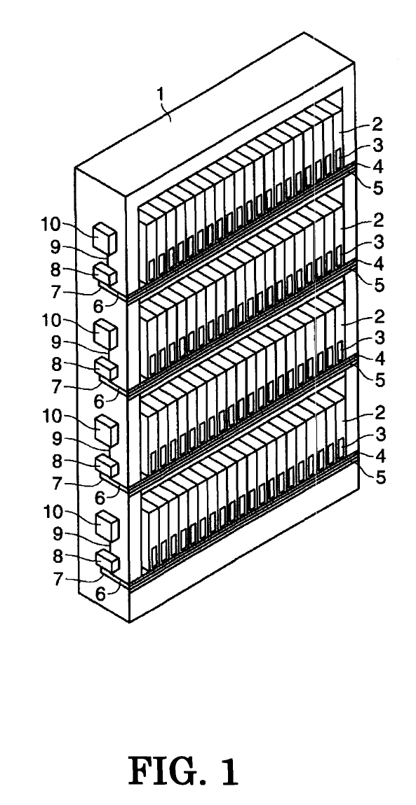

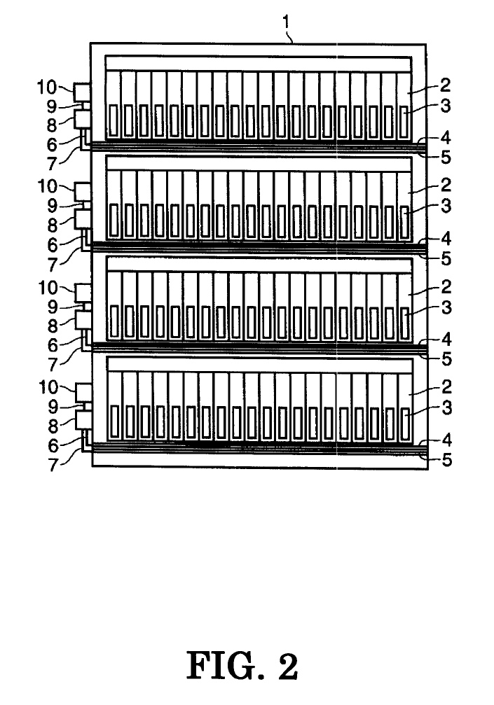

FIGS. 1 and 2 show an bookshelf 1, acting as an article container, which includes a radio-communication apparatus, an antenna device having first and second leakage transmission lines and a switch. Bookshelf 1 stores or displays a plurality of books (articles) 2, arranged thereon. An RFID tag 3, acting as a data carrier, is attached to each spine of the books. The article container includes bookshelves, showcases, supermarket shelves, boxes and so on, which display or house articles.

On front surface of each shelf portion of bookshelf 1 forming an article containing portion, a first and second leakage transmission lines 4 and 5 are arranged in parallel in a direction longitudinal to the each shelf portion. Each of the leakage transmission lines 4 and 5 is formed of a balanced line, e.g., feeder, in which two conductors are capable of being operated so that the voltages of the two conductors at any transverse plane are equal in magnitude and opposite in polarity with respect to the ground. The balanced line can be available as an antenna element for a radio-communication within a short communication range using leakage radio wave therefrom. A leaky coaxial cable or microstrip line may be available as another leakage transmission line.

Start terminals of first and second transmission lines 4 and 5 are connected to a switch 8, forming switching means, mounted on a side of bookshelf 1, through cables 6 and 7 such as coaxial cables. Switch 8 is connected to an RFID tag reader 10 forming a radio-communication apparatus mounted on the same side of bookshelf 1, through a cable 9 such as a coaxial cable.

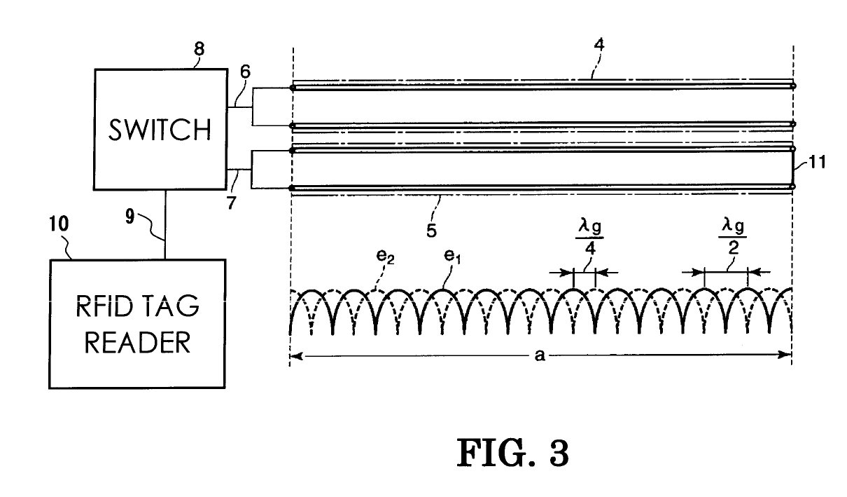

FIG. 3 shows a structure of first and second transmission lines 4 and 5, each having length of “a.” The transmission lines 4 and 5 are arranged in parallel, and end terminals thereof are mutually aligned. The end terminal of first transmission line 4 is opened. The end terminal of second transmission line 5 is short-circuited by a short-circuit element 11. In lieu of short-circuit element 11, a characteristic impedance of the transmission line or a resistor for the end terminal may be applied to short-circuit.

In this structure, transmitted signals out of RFID tag reader 10 propagate through transmission lines 4 and 5 as a forward wave having a wavelength of λg. The signals propagated through the transmission lines 4 and 5 are reflected at the respective end terminals and returned to the transmission lines in a way of a backward wave having the same wavelength λg. Composite waveform of the forward and backward waves generates a standing wave having a cycle of λg/2 in the transmission lines. Electric field intensities generated by radio waves leaked from first and second leakage transmission lines 4 and 5 within a short communication range are cyclically distributed as shown by solid line e1 and dashed line e2 respectively, each having a distribution pattern of the same length (cycle of λg/2) as that of the standing wave. Besides, because the end terminal of first transmission line 4 is opened and that of second transmission line 5 is short-circuited, the distribution patterns in the electric field intensity generated by the radio waves leaked from the transmission lines 4 and 5 are mutually shifted by a length of λg/4. In other words, the electric field intensities e1 and e2 generated by radio wave from first and second leakage transmission lines 4 and 5 are fluctuated to mutually compensate reduced portions of one distribution pattern with the other distribution pattern and vice versa.

When RFID tag reader 10 reads respective data stored in RFID tags attached to books 2 which are displayed on bookshelf 1, firstly switch 8 connects RFID tag reader 10 to first leakage transmission line 4 acting as an antenna. On the connection therebetween RFID tag reader 10 sequentially reads data stored in respective RFID tags 3 attached to books 2.

However, reduced portions of a distribution pattern in an electric field intensity e1 on first leakage transmission line 4 may cause RFID tag reader 10 to fail to read data from RFID tag 3. To solve the problem, secondly, switch 8 connects RFID tag reader 10 to second leakage transmission line 5. On the connection therebetween, RFID tag reader 10 sequentially reads data stored in respective RFID tags 3 attached to books 2. Switching between first and second transmission lines 4 and 5 causes RFID tag reader 10 to read data stored in RFID tag 3 which can not be read by one transmission line.

Since first and second transmission lines 4 and 5, as antennas, are alternatively or selectively connected to RFID tag reader 10, data reading out of all of RFID tags 3 attached to books 2 arranged in bookshelf 1 can be made. For the reason of alternative connection, a radio communication between RFID tags attached to all books and RFID tag reader 10 can be made at one time operation, that is to say that machine-readability from RFID tag by the reader is improved, resulting in less workload of an operator.

In this configuration, switching of the connection is frequently implemented when monitoring all books is always required, and the switching is implemented at a prescribed time interval when monitoring all books 2 is required at the prescribed time. In other words, frequency of the switching is determined according to how to manage books.

### Second Embodiment

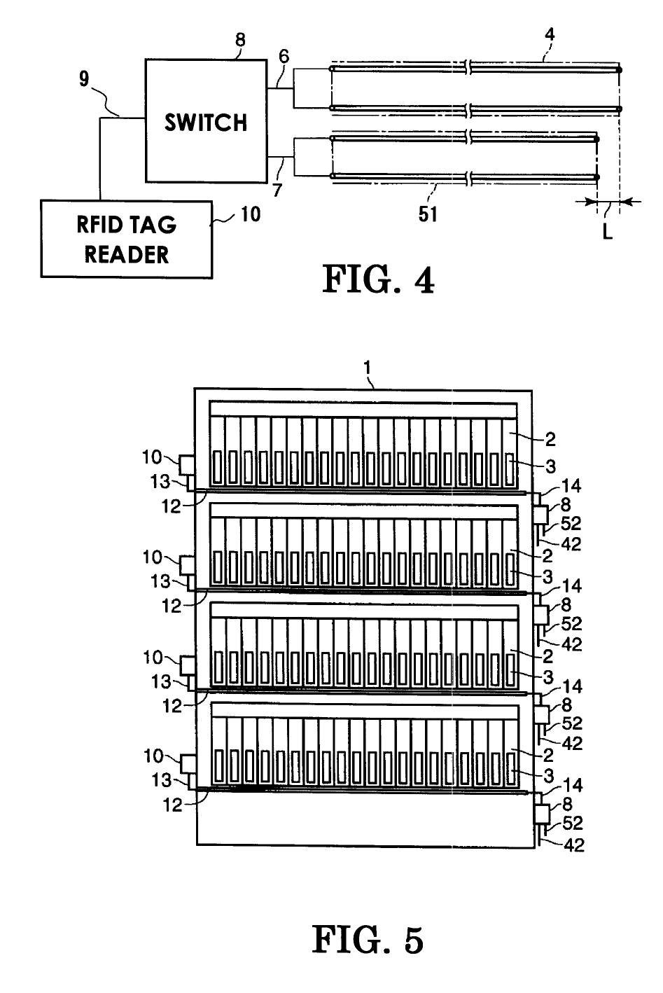

In the second embodiment, modification of the second leakage transmission line is made, and other configurations except for the transmission line are the same as the first embodiment. Thus detailed description of other configurations is omitted. In place of the structure of the second leakage transmission line in which an end terminal of a balanced line is short-circuited, in this embodiment the balanced line includes an end terminal being opened and a length thereof is shorter than first leakage transmission line 4, as indicated in FIG. 4.

In detail, each of first and second transmission lines 4 and 51 defines start and end terminals and has a length, wherein the start terminals are mutually aligned, the first and second transmission lines 4 and 51 are arranged in parallel, and the length of second transmission line 51 is formed to be shorter than first transmission line 4 by a difference (L). In other words, first and second transmission lines 4 and 51 are formed including difference (L) in length between the end terminals thereof. Difference (L) in length is set to be L=(2n−1)×λg/4, where n is a natural number and λg is a wavelength propagating in transmission line. The formula indicates that the difference (L) in length may be set to a value multiplying λg/4 by odd number.

The foregoing structure causes electric field intensities within a short communication range generated by radio waves leaked from first and second transmission lines 4 and 51 to distribute at a cycle of λg/2 respectively and causes each distribution pattern of the electric fields to mutually shift by λg/4. This is because that a length of the second transmission line 51 is shorter than that of the first transmission line 4 by (2n−1)×λg/4. That is to say, the electric field intensity of second transmission line 51 fluctuates with respect to that of first transmission line 4 so that one distribution pattern in electric field intensity compensates reduced portions of the other distribution pattern and vice versa.

Hence, in this embodiment also, since first and second transmission lines 4 and 51 acting as antenna are alternatively or selectively connected to the RFID tag reader 10, data reading out of all of RFID tags 3 attached to books 2 arranged in bookshelf 1 can be made. For the reason of alternative connection, a radio communication between RFID tags attached to all books and RFID tag reader 10 can be made at one time operation, that is to say that a machine-readability between RFID tag and the RFID tag reader 10 is improved, resulting in less workload of an operator. Incidentally, instead of first and second transmission lines 4 and 51 whose end terminals are opened described in this embodiment, first and second transmission lines 4 and 51 whose end terminals are short-circuited may be available.

### Third Embodiment

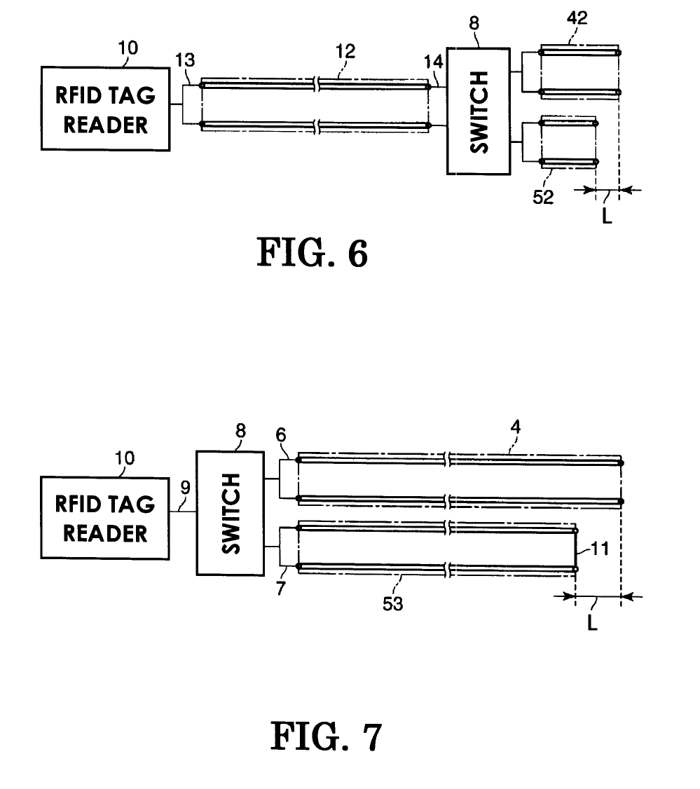

Referring to FIGS. 5 and 6, third embodiment will now be described. A bookshelf 1 has a plurality of shelve portions. An RFID tag reader 10 is mounted on a side surface of bookshelf 1, corresponding to each shelf portion. A switch 8 is mounted on the other side surface of bookshelf 1, corresponding to each shelf portion. A third leakage transmission line 12 composed of a balanced line is arranged on a front surface of the respective shelves in a direction longitudinal to the shelf.

One terminal of third transmission line 12 is connected with RFID tag reader 10 via a cable 13, and the other terminal thereof is connected with switch 8 via a cable 14, wherein cables 13 and 14 are, for example, coaxial cables. First and second transmission lines 42 and 52, each of which is composed of a balanced line, are respectively connected with switch 8.

Referring to FIG. 6, first and second transmission lines 42 and 52 are formed in parallel such that both end terminals thereof are opened and second transmission line 52 is shortened by difference (L) in length with respect to first transmission line 42, both start terminals of transmission lines 42 and 52 being mutually aligned. In other words, first and second transmission lines 42 and 52 are formed including difference (L) in length between the end terminals thereof. The difference (L) in length is set to be L=(2n−1)×λg/4, where n is a natural number and λg is a wavelength propagating in transmission line.

In this structure switch 8 is controlled to selectively connect first or second transmission line 42 or 52 with third transmission line 12. The selective connection causes electric field intensity within a short communication range generated by a radio wave leaked from third transmission line 12 to fluctuate at a cycle of λg/2 and causes distribution patterns in the electric field intensity generated by the radio wave from third transmission line 12 when first transmission line 42 is connected to third transmission line 12 and in that when second transmission line 52 is connected to third transmission line 12 to mutually shift by a length of λg/4. Hence the electric fields within the vicinity of third transmission line 12 respectively generated when first transmission line 52 is connected thereto and when second transmission line 52 is connected thereto distribute to compensate reduced portions of one distribution pattern in the electric field intensity by the other distribution pattern and vice versa.

Accordingly, third transmission line 12 is alternatively or selectively connected with first and second transmission lines 42 and 52 by switch 8 so that third transmission line 12 functions as an antenna for RFID tag reader 10. By means of third transmission line 12 acting as an antenna, RFID tag reader 10 can read stored data in RFID tags of all of books 2 arranged on the shelf at one time operation, that is to say, a radio communication with all RFID tags can be effectively made. Thus, RFID tag reader 10 can alleviate an excessive workload of an operator to read data stored in RFID tags.

In addition to the above-described effect, since one leakage transmission line, i.e., only third transmission line 12 is attached on a front surface of each shelf, comparing with the arrangement including two leakage transmission lines, it is not required to adjust positioning and/or parallel degree in a longitudinal direction between the two transmission lines. No matter which third transmission line 12 is connected with either first or second transmission line 42 or 52, it can be precisely shifted by λg/4 between distribution patterns in electric field intensity respectively generated when first and second transmission lines 42 and 52 are selectively connected to third transmission line 12. Also compensation to reduced portions of each electric field generated from third transmission line 12 can be achieved more accurately. Incidentally, instead of first and second transmission lines 42 and 52 whose end terminals are opened described in this embodiment, first and second transmission lines 42 and 52 whose end terminals are short-circuited may be available.

### Fourth Embodiment

An antenna device in this embodiment will be now described in which a modification of the second leakage transmission line of the first embodiment set forth above is provided. Other, structures are the same as those of the first embodiment. As shown in FIG. 7, a second leakage transmission line 53, such as a balanced line, has an end terminal being short-circuited by a short-circuit-element 11 and has a shorter length with respect to first leakage transmission line 4.

In detail, first and second transmission lines 4 and 53 are arranged such that respective start terminals thereof are mutually aligned and the transmission lines extend in parallel, second transmission line 53 having a shorter length by difference (L) in comparison with first transmission line 4. In other words, first and second transmission lines 4 and 53 are respectively formed including difference (L) in length between the end terminals thereof. The difference (L) in length is set to be L=n×λg/2, where n is a natural number and λg is wavelength propagating in transmission line. The formula indicates that the difference (L) in length may be set to a value multiplying λg/2 by an integer.

A value λg/2 in this structure, also, indicates a cycle of fluctuation in electric field intensity within the vicinity of first and second transmission lines 4 and 53. Thus, even if second transmission line 53 is shortened to form a difference in length between the end terminals of the first and second transmission lines being n×λg/2 (a first case), second transmission line 53 in the first case generates the same distribution pattern in electric field intensity as second transmission line which does not shorten by n×λg/2 (a second case). A relative location of each distribution pattern in electric field intensity of the first case and the second case against the location of the distribution pattern in electric filed intensity (f first transmission line 4 is not changed with one another.

This structure causes a distribution pattern of electric field intensity within a short communication range generated by a radio wave leaked from second transmission line 53 to mutually shift by “λg/4” with respect to that from first transmission line 4, in a similar way of structure in which end terminals of first and second transmission lines 4 and 53 are aligned. Therefore, reduced portions of distribution pattern in electric field intensity of one transmission line can be compensated with that of the other transmission line and vice versa.

Hence, since first and second transmission lines 4 and 53 acting as an antenna are alternatively or selectively connected to the RFID tag reader 10, data reading out of all of RFID tags 3 attached to books 2 arranged in bookshelf 1 can be made. For the reason of alternative connection, a radio communication between RFID tags attached to all books and RFID tag reader 10 can be made at one time operation, that is to say, machine readability between RFID tag and the RFID tag reader 10 is improved, resulting in less workload of an operator.

### Fifth Embodiment

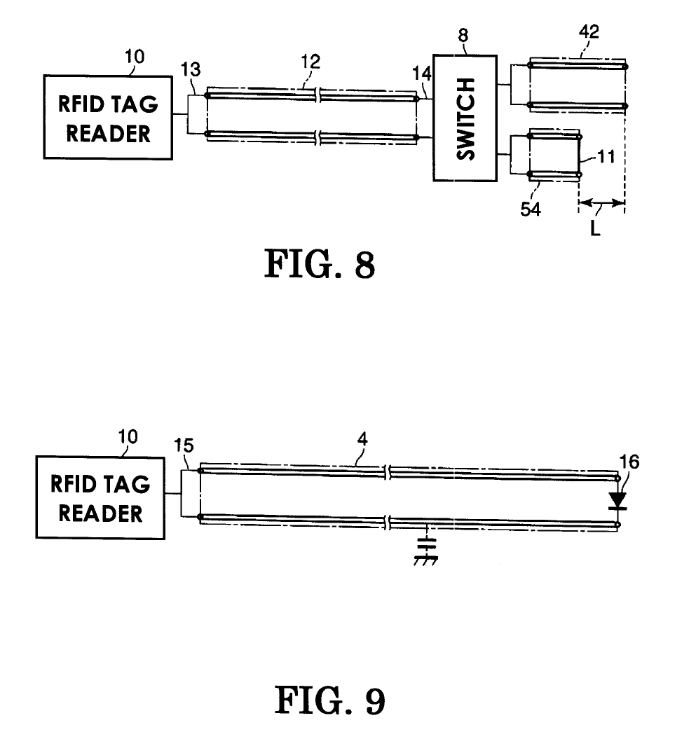

An antenna device in this embodiment will be now described in which a modification of second leakage transmission line of the third embodiment set forth above is provided. Other structures are the same as the third embodiment. As shown in FIG. 8, second leakage transmission line 54, such as a balanced line, has an end terminal being short-circuited by a short-circuit-element 11 and is shortened by a difference (L) in length with respect to first leakage transmission line 42.

In detail, first and second transmission lines 42 and 54 are arranged such that respective start terminals thereof are mutually aligned and the transmission lines extend in parallel, second transmission line 54 having a shorter length by a difference (L) in comparison with first transmission line 42. In other words, first and second transmission lines 42 and 54 are respectively formed including difference (L) in length between the end terminals thereof The difference (L) in length is set to be L=n×λg/2, where n is a natural number and λg is a wavelength propagating in transmission line. The formula indicates that the difference (L) in length may be set to a value multiplying λg/2 by an integer.

A value λg/2 in this structure, also, indicates a cycle of fluctuation in electric field intensity within the vicinity of first and second transmission lines 42 and 54. Thus, even if second transmission line 54 is shortened to form a difference (L) in length between the end terminals of the first and second transmission lines being n×λg/2, a shift amount between distribution patterns in electric field intensity generated by first and second transmission lines 42 and 54 is λg/4 that is the same as that between distribution patterns when the end terminals of first and second transmission lines 42 and 54 are aligned.

In this configuration switch 8 is controlled to selectively connect first and second transmission lines 42 and 54 with third transmission line 12. The selective connection causes electric field intensity within a short communication range generated by a radio wave leaked from third transmission line 12 to fluctuate at a cycle of λg/2 respectively and causes distribution patterns in the electric field intensity generated by the radio wave from third transmission line 12 when first transmission line 42 is connected to third transmission line 12 and in that when second transmission line 54 is connected to third transmission line 12 to mutually shift by a length of λg/4. Hence the electric field within the vicinity of third transmission line 12 respectively generated when first transmission line 42 is connected thereto and when second transmission line 54 is connected thereto distributes to compensate reduced portions of one fluctuation pattern in the electric field intensity by the other fluctuation pattern and vice versa.

Accordingly, third transmission line 12 is alternatively connected with first and second transmission line 42 and 54 by switch 8, and the RFID tag reader 10 can read data stored in RFID tags of all books 2 arranged on a shelf at one time operation, using third transmission line 12 as an antenna. Communication with all RFID tags can be effectively made. Thus, RFID tag reader 10 can read data stored in RFID tags without any excessive workload of an operator.

In addition to the above-described effect, since single leakage transmission line arrangement in which only third transmission line 12 is attached on a front surface of each shelf is adopted, it is not required to adjust a positioning and/or a parallel degree in a longitudinal direction between the two transmission lines, as is the case of the foregoing third embodiment. No matter which third transmission line 12 is connected with either first or second transmission line 42 or 54, it can be precisely shifted by λg/4 between distribution patterns in electric field intensity respectively generated by the radio wave leaked from the third transmission line when first and second transmission lines 42 and 54 are selectively connected to third transmission line 54. Also compensation to reduced portions of electric field generated from third transmission line 12 can be achieved more accurately.

### Sixth Embodiment

With reference to FIG. 9, an antenna device in this embodiment will be described. The antenna device includes one leakage transmission line 4, such as a balanced line, and a switching element connected with an end terminal thereof. A start terminal of transmission line 4 is connected with RFID tag reader 10 through a cable 15, such as a coaxial cable.

The switching element is composed of a diode 16 which is connected between two conductors of end terminal of the transmission line 4 (balanced line) to selectively make the end terminal to be in either an open state or a short-circuit state. The transmission line 4 is attached to a front surface of respective shelves in a longitudinal direction thereof provided in a bookshelf.

In operation of the above-described antenna device, when direct current is blocked by diode 16 because of applying an DC voltage in a reverse direction of diode 16, the end terminal of the transmission line 4 forms an open state by virtue of no current flowing through diode 16. On the other hand, when direct current flows to diode 16 via transmission line 4 and stray capacity because of applying an DC voltage in a normal direction of diode 16, the end terminal of the transmission line 4 forms a short-circuit state by virtue of current flowing through diode 16.

By the use of diode 16, electric field intensity within a short communication range generated by a radio wave leaked from transmission line 4 is fluctuated at a cycle of λg/2 in both open and short-circuit states, and a distribution pattern of the electric field in the open state is shifted by λg/4 with respect to that in the short-circuit state. The shift of distribution pattern results in compensation for reduced portions of one distribution pattern in electric field intensity by the other distribution pattern and vice versa.

In this structure, RFID tag reader uses transmission line 4 functioning as an antenna by selecting either open state or short-circuit state, and thus realizing data reading from all of the RFID tags attached to respective books arranged in bookshelf 1 at one time. Hence, a radio communication between all of RFID tags of books and RFID tag reader 10 is efficiently implemented. Accordingly, an excess workload of an operator is also alleviated.

In addition to the above-described effect, since one leakage transmission line such as first transmission line 4 is attached on a front surface of each shelf, it is not required to adjust a positioning and/or a parallel degree in a longitudinal direction between the two transmission lines, as is the case of the foregoing third embodiment. Also, it can be precisely shifted by λg/4 between distribution patterns in intensity of electric field generated by a radio wave leaked from the third transmission line within the vicinity thereof by switching the open state and the short-circuit state of the end terminal of one transmission line. Also compensation to reduced portions of distribution patterns in electric field intensity can be achieved more accurately.

Incidentally, although a diode acting as an switching element that realizes either an open state or a short-circuit state is described as an example in this embodiment, the switching element is not limited to the diode. A mechanical switch or semiconductor switch may also be available for the switching element.

Furthermore, in these embodiments described-above, a radio communication between RFID tags attached to books stored or displayed on a bookshelf and the RFID tag reader is described, using books as articles and a bookshelf as an article container. However, the radio communication of the present invention is not limited to those, and other merchandise items, e.g., compact discs, foods, beverages, and so on, displayed on a showcase may also be available.

The present invention has been described with respect to specific embodiments. However, other embodiments based on the principles of the present invention should be obvious to those of ordinary skill in the art. Such embodiments are intended to be covered by the claims.

What is claimed is:

1. An antenna device used in a radio-communication between a radio communication apparatus and a data carrier within a short communication range, comprising:
a first leakage transmission line, functioning as an antenna element, which generates leakage radio waves having a first distribution pattern in an electric field intensity;
a second leakage transmission line, functioning as an antenna element, which generates leakage radio waves having a second distribution pattern in an electric field intensity, the second distribution pattern being shifted by λg/4 with respect to the first distribution pattern where λg is a wavelength propagating in the first and second transmission lines; and
a switch configured to selectively connect the first and second transmission lines to the radio communication apparatus when carrying out the radio communication.

2. An antenna device used in a radio-communication between a radio communication apparatus and a data carrier within a short communication range, comprising:
a first leakage transmission line functioning as an antenna element and having an end terminal being opened;
a second leakage transmission line functioning as an antenna element and having an end terminal being short-circuited, the first and second transmission lines being arranged in parallel, end terminals of the first and second transmission lines being aligned; and
a switch configured to selectively connect the first and second transmission lines to the radio communication apparatus when carrying out the radio communication.

3. An antenna device used in a radio-communication between a radio communication apparatus and a data carrier within a short communication range, comprising:
a first leakage transmission line functioning as an antenna element and having an end terminal being opened;
a second leakage transmission line functioning as an antenna element and having an end terminal being opened, the first and second transmission lines being arranged in parallel, the end terminal of the second transmission line being arranged to form a difference (L) in length with respect to the end terminal of the first transmission line; and
a switch configured to selectively connect the first and second transmission lines with the radio communication apparatus when carrying out the radio communication,
wherein the difference (L) in length is determined by the following formula:
L=(2n−1)×λg/4
wherein n is a natural number and λg is a wavelength propagating in the first and second transmission lines.

4. The antenna device according to claim 3 further including a short-circuit elements, the end terminals of the first and second transmission lines being respectively short-circuited by the short-circuit elements.

5. The antenna device according to claim 3, further including a third leakage transmission line interposed in an electrical connection between the radio communication apparatus and the switch, the first and second leakage transmission lines being selectively connected by the switch to the radio communication apparatus through the third leakage transmission line.

6. The antenna device according to claim 5 further including short-circuit elements, the end terminals of the first and second transmission lines being respectively short-circuited by the short-circuit elements.

7. An antenna device used in a radio-communication between a radio communication apparatus and a data carrier within a short communication range, comprising:
a first leakage transmission line functioning as an antenna element and having an end terminal being opened;
a second leakage transmission line functioning as an antenna element and having an end terminal being short-circuited, the first and second transmission lines being arranged in parallel, the end terminal of the second transmission line being arranged to form a difference (L) in length with respect to the end terminal of the first transmission line; and
a switch configured to selectively connect the first and second transmission lines with the radio communication apparatus when carrying out the radio communication,
wherein the difference (L) in length is determined by the following formula:
L=n×λg/2
wherein n is a natural number and λg is a wavelength propagating in the first and second transmission lines.

8. The antenna device according to claim 7, further including a third leakage transmission line interposed in an electrical connection between the radio communication apparatus and the switch, the first and second leakage transmission lines being selectively connected by the switch to the radio communication apparatus through the third leakage transmission line.

9. An antenna device used in a radio-communication between a radio communication apparatus and a data carrier within a short communication range, comprising:
a leakage transmission line functioning as an antenna element and having a start terminal connected with the radio communication apparatus and an end terminal; and
a switching element configured to selectively make the end terminal to be in either an open-state or a short-circuit state when carrying out the radio communication.

10. The antenna device according to claim 9, wherein the switching element includes a diode through which direct current flows to make the end terminal to be in a short-circuit state.

11. An article container provided with an antenna device set forth in claim 1, comprising:
a plurality of articles each of which the data carrier is attached to; and
an article containing portion on which the first and second leakage transmission lines are arranged to carry out a radio-communication with the data carriers of the articles.

12. An article container provided with an antenna device set forth in claim 9, comprising:
a plurality of articles each of which the data carrier is attached to; and
an article containing portion on which the leakage transmission line is arranged to carry out a radio-communication with the data carriers of the articles.
